(19) United States
(12) Patent Application Publication
(10) Pub. No.: US 2003/0105252 A1
(43) Pub. Date: Jun. 5, 2003

(54) Amido half sandwich metallocene catalyst system and its preparation and use

(76) Inventors: Alexander Reb, Dresden/Weixdorf (DE); Helmut G. Alt, Bayreuth (DE); M. Bruce Welch, Bartlesville, OK (US)

Correspondence Address: CHEVRON PHILLIPS CHEMICAL COMPANY LP, LAW DEPARTMENT - IP, P.O BOX 4910, THE WOODLANDS, TX, 77387-4910, US

(21) Appl. No.: 10/002,681

(22) Filed: Oct. 31, 2001

(51) Int. Cl. C08F 4/44; B01J 31/00

(52) U.S. Cl. 526/127; 526/160; 526/943; 526/352; 526/348.5; 526/904; 502/117; 502/108

(57) ABSTRACT

A solid particulate metallocene-containing catalyst system is produced by combining an alkenyl substituted indenyl (t-butylamido)dimethyl silane titanium dichloride half sandwich metallocene in which the alkenyl substituent on the indenyl has terminal olefinic unsaturation and 5 to 6 carbon atoms with a suitable cocatalyst in a liquid and conducting prepolymerization of at least one olefin, optionally in multiple steps, to produce a prepolymerized solid catalyst, and separating the resulting solid from the liquid and the components dissolved in the liquid, said solid being the inventive solid particulate metallocene catalyst system. The use of the solid particulate catalyst in the polymerization of olefins is also disclosed.

### FIELD OF THE INVENTION

This invention relates to a process for producing a new type of solid particulate metallocene catalyst system useful for the polymerization and/or copolymerization of olefins. The invention is also related to a process for conducting polymerization of olefins using the inventive solid metallocene catalyst system.

### BACKGROUND OF THE INVENTION

The term “Metallocene” as used herein refers to a derivative of cyclopentadienylidene which is a metal derivative containing at least one cyclopentadienyl component which is bonded to a transition metal. The transition metal is selected from Groups IVB, VB, and VIB, preferably IVB and VIB. Examples include titanium, zirconium, hafnium, chromium, and vanadium. A number of metallocenes have been found to be useful for the polymerization of olefins. Generally, the more preferred catalysts are metallocenes of Zr, Hf, or Ti.

Generally, in order to obtain the highest activity from metallocene catalysts, it has been necessary to use them with an organoaluminoxane cocatalyst, such as methylaluminoxane. This resulting catalyst system is generally referred to as a homogenous catalyst system since at least part of the metallocene or the organoaluminoxane is in solution in the polymerization media. These homogenous catalysts systems have the disadvantage that when they are used under slurry polymerization conditions, they produce polymer which sticks to reactor walls during the polymerization process and/or polymer having small particle size and low bulk density which limits the commercial utility.

Some attempts to overcome the disadvantages of the homogenous metallocene catalyst systems are disclosed in U.S. Pat. Nos. 5,240,894, 4,871,705; and 5,106,804. Typically, these procedures have involved the prepolymerization of the metallocene aluminoxane catalyst system either in the presence of or in the absence of a support. An evaluation of these techniques has revealed that there is still room for improvement, particularly when the catalyst is one which is to be used in a slurry type polymerization where the object is to produce a slurry of insoluble particles of the end product polymer rather than a solution of polymer which could result in fouling of the reactor. In the operation of a slurry polymerization in a continuous loop reactor it is extremely important for efficient operations to limit polymer fouling of the internal surfaces of the reactor. The term “fouling” as used herein refers to polymer buildup on the surfaces inside the reactor.

An improved type of solid metallocene catalyst composition that can be used in a slurry polymerization process was revealed in U.S. Pat. No. 5,498,581, the disclosure of which is incorporated herein by reference. That catalyst composition was prepared by combining a cocatalyst with a metallocene that had an olefinically unsaturated substituent, subjecting that mixture to prepolymerization with an olefin in the presence of a liquid to produce a solid prepolymerized catalyst, and separating the resulting prepolymerized catalyst from the liquid and the components dissolved in the liquid. Some specific variations of producing such catalysts are disclosed in WO 99/29738 and WO 98/52686, the disclosures of which are also incorporated herein by reference.

The preparation of prepolymerized metallocene catalyst systems is also disclosed in European Patents 586,167 and 586,168 and in U.S. Pat. Nos. 5,714,425 and 5,714,555, the disclosures of which are incorporated herein by reference. Those patents disclose preparing such prepolymerized catalysts from half sandwich (t-butyl amido) dimethyl silane titanium metallocenes such as (3-propenylcyclopentadienyl) dimethyl silane (t-butyl) zirconium dichloride. Numerous patents disclose the use of half sandwich (t-butyl amido) type metallocenes to polymerized olefins. Some examples include European Patent 416,815 and U.S. Pat. Nos. 5,026,798; 5,317,036; and 5,399,635, the disclosures of which are incorporated herein by reference.

The present inventors have previously discovered that certain alkenyl substituted cyclodienyl dimethyl silane (t-butyl) titanium half sandwich metallocenes are in the unprepolymerized state more active than other alkenyl substituted alkenyl cyclodienyl dimethyl silane (t-butyl) titanium half sandwich metallocenes. That discovery is disclosed in U.S. patent application Ser. No. 09/220,866 filed Dec. 23, 1998. The disclosure of that application is incorporated herein by reference. The inventors of this application have now discovered that an even more active catalyst can be prepared if certain specific types of half sandwich metallocenes are subjected to prepolymerization.

An object of the present invention is to provide an unusually active prepolymerized using an alkenyl substituted indenyl (t-butylamido)dimethyl silane titanium half sandwich type metallocene in which the alkenyl substituent on the indenyl has terminal olefinic unsaturation and 5 to 6 carbon atoms. In accordance with another aspect of the present invention, there is provided a method for polymerizing olefins using such solid prepolymerized metallocene catalyst systems.

### SUMMARY OF THE INVENTION

In accordance with the present invention, a solid particulate metallocene-containing catalyst system is produced by combining an alkenyl substituted indenyl (t-butylamido) dimethyl silane titanium half sandwich metallocene in which the alkenyl substituent on the indenyl has terminal olefinic unsaturation and 5 to 6 carbon atoms with a suitable cocatalyst in a liquid and conducting prepolymerization of at least one olefin, optionally in multiple steps, to produce a prepolymerized solid catalyst, and separating the resulting solid from the liquid and the components dissolved in the liquid, said solid being the inventive solid particulate metallocene catalyst system.

In accordance with another aspect of the present invention, the resulting inventive solid particulate metallocene-containing catalyst system is employed in the polymerization of an olefin by contacting the olefin with the inventive solid particulate metallocene-containing catalyst system under suitable reaction conditions.

### DETAILED DESCRIPTION OF THE INVENTION

The half sandwich metallocenes that are used in the present invention include those in which the dimethyl silyl is bonded to a carbon of the cyclopentadienyl portion of the indenyl that is adjacent the cyclohexenyl portion of the indenyl. The alkenyl substituent can be at either the 1 or 2 position relative to the bond between the dimethyl silyl and the indenyl. Some examples include 1-(3-pent-4-enyl indenyl) dimethyl silyl t-butyl titanium dichloride, 1-(3-pent-4-enyl indenyl) dimethyl silyl t-butyl titanium dimethyl, 1-(3-hex-5-enyl indenyl) dimethyl silyl t-butyl titanium dichloride, 1-(3-hex-5-enyl indenyl) dimethyl silyl t-butyl titanium dimethyl, and the like. The chloride or methyl groups could be replaced by other groups known to generally be equivalent such as other halides or other organo groups such as other alkyls.

The cocatalyst employed in the prepolymerization can be selected from generally any organometallic cocatalyst that is known to be capable of activating the half sandwich amido type metallocenes. Examples include organometallic compounds of the metals of Groups IA, IIA, IIB, and IIIB of the Periodic Table. Generally the preferred cocatalysts are organometallic compounds of lithium, aluminum, magnesium, zinc, or boron. An example of an organoboron cocatalyst would be tetra(pentafluorophenyl) boron. Some examples of suitable organic aluminum compounds include the trialkyl, alkyl hydrido, alkyl halo, and alkyl alkoxy compounds of aluminum. It is also within the scope of the present invention to use as the cocatalyst a fluorinated silica alumina of the type disclosed in WO 99/60033, the disclosure of which is incorporated herein by reference. Another cocatalyst which could be employed is the product resulting from the reaction of dehydrated silica with trimethyl aluminum followed by the addition of water, such as disclosed in U.S. Pat. No. 5,900,035, the disclosure of which is incorporated herein by reference.

A particularly preferred cocatalyst is an organo aluminoxane is an oligomeric aluminum compound having repeating units of the formula

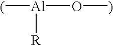

Some examples are often represented by the general formula (R-Al—O)ₙ or R(R-Al—O)ₙAlR². In the general alumoxane formula R is a C₁-C₅ alkyl radical, for example, methyl, ethyl, propyl, butyl or pentyl and “n” is an integer from 1 to about 50. Most preferably, R is methyl and “n” is at least 4. Aluminoxanes can be prepared by various procedures known in the art. For example, an aluminum alkyl may be treated with water dissolved in an inert organic solvent, or it may be contacted with a hydrated salt, such as hydrated copper sulfate suspended in an inert organic solvent, to yield an aluminoxane. Generally the reaction of an aluminum alkyl with a limited amount of water is postulated to yield a mixture of the linear and cyclic species of the aluminoxane.

In the first step of the present invention, the metallocene and cocatalyst are combined in liquid. Typically the liquid would be selected from aliphatic or aromatic hydrocarbons. Examples of aromatic hydrocarbons include benzene, toluene, ethylbenzene, diethylbenzene, and xylenes and the like. Examples of what is meant by aliphatic liquid include pentane, isopentane, hexane, octane, heptane, and the like. The amount of liquid employed should preferably be such as to allow for good mixing in the subsequent steps and to allow for a desirable viscosity during the prepolymerization step.

One preferred embodiment uses as the cocatalyst an aluminoxane that is dissolved in an aromatic liquid, preferably liquid toluene. The amount of liquid in which the aluminoxane is dissolved is not particularly critical, however the aromatic liquid is commonly used in such an amount that the aluminoxane solution would contain about 5 to about 40 weight percent aluminoxane, more preferably about 10 to about 30 weight percent.

In combining the metallocene and the cocatalyst the temperature is preferably kept below that which would cause the metallocene to decompose. Typically the temperature would be in the range of −50° C. to 100° C. When aluminoxane is employed the metallocene, the aluminoxane, and the liquid diluent are generally combined at room temperature, i.e. around 10 to 30° C. The reaction between the aluminoxane and the metallocene is relatively rapid. The reaction rate can vary depending upon the ligands of the metallocene. It is generally desired that they be contacted for at least about a minute to about 1 hour.

It is within the scope of the invention to form the liquid catalyst system in the presence of a particulate solid. Any number of particulate solids can be employed as the particulate solid. Typically the particulate solid can be any organic or inorganic solid that does not interfere with the desired end result. Examples include porous supports such as talc, inorganic oxides, and resinous support materials such as particulate polyolefins. Examples of inorganic oxide materials include oxides of metals of Groups II, III, IV or V of the Periodic Table, such as silica, alumina, silica-alumina, and mixtures thereof. Other examples of inorganic oxides are magnesia, titania, zirconia, and the like. Other suitable support materials which can be employed include such as, magnesium dichloride, and finely divided polyolefins, such as polyethylene. It is within the scope of the present invention to use a mixture of one or more of the particulate solids.

It is generally desirable for the particulate solid to be thoroughly dehydrated prior to use, preferably it is dehydrated so as to contain less than 1% loss on ignition. Thermal dehydration treatment may be carried out in vacuum or while purging with a dry inert gas such as nitrogen at a temperature of about 20° C. to about 1000° C., and preferably, from about 300° C. to about 800° C. Pressure considerations are not critical. The duration of thermal treatment can be from about 1 to about 24 hours. However, shorter or longer times can be employed provided equilibrium is established with the surface hydroxyl groups.

Dehydration can also be accomplished by subjecting the solid to a chemical treatment in order to remove water and reduce the concentration of surface hydroxyl groups. Chemical treatment is generally capable of converting all water and hydroxyl groups in the oxide surface to relatively inert species. Useful chemical agents are for example, trimethylaluminum, ethyl magnesium chloride, chlorosilanes such as SiCl₄, disilazane, trimethylchlorosilane, dimethylaminotrimethylsilane and the like.

The chemical dehydration can be accomplished by slurrying the inorganic particulate material such as, for example silica, in an inert low boiling hydrocarbon, such as for example, hexane. During the chemical dehydration treatment, the silica should be maintained in a moisture and oxygen free atmosphere. To the silica slurry is then added a low boiling inert hydrocarbon solution of the chemical dehydrating agent, such as, for example dichlorodimethylsilane. The solution is added slowly to the slurry. The temperature ranges during chemical dehydration reaction can be from about 20° C. to about 120° C., however, higher and lower temperatures can be employed. Preferably, the temperature will be about 50° C. to about 100° C. The chemical dehydration procedure should be allowed to proceed until all the substantially reactive groups are removed from the particulate support material as indicated by cessation of gas evolution. Normally, the chemical dehydration reaction will be allowed to proceed from about 30 minutes to about 16 hours, preferably, 1 to 5 hours. Upon completion of the chemical dehydration, the solid particulate material may be filtered under a nitrogen atmosphere and washed one or more times with a dry, oxygen free inert solvent. The wash solvents as well as the diluents employed to form the slurry and the solution of chemical dehydrating agent, can be any suitable inert hydrocarbon. Illustrative of such hydrocarbons are pentane, heptane, hexane, toluene, isopentane and the like.

Another chemical treatment that can be used on solid inorganic oxides such as silica involves reduction by contacting the solid with carbon monoxide at an elevated temperature sufficient to convert substantially all the water and hydroxyl groups to relatively inactive species.

The specific particle size of the support or inorganic oxide, surface area, pore volume, and number of hydroxyl groups is not considered critical to its utility in the practice of this invention. However, such characteristics often determine the amount of support to be employed in preparing the catalyst compositions, as well as affecting the particle morphology of polymers formed. The characteristics of the carrier or support must therefore be taken into consideration in choosing the same for use in the particular invention.

It is also within the scope of the present invention to add such a particulate solid to the liquid catalyst system after it has been formed and to carry out the prepolymerization in the presence of that solid.

The amount of aluminoxane and metallocene used in forming the liquid catalyst system for the prepolymerization can vary over a wide range. Typically, however, the molar ratio of aluminum in the aluminoxane to transition metal of the metallocene is in the range of about 1:1 to about 20,000:1, more preferably, a molar ratio of about 50:1 to about 2000:1 is used. If a particulate solid, i.e. silica, is used generally it is used in an amount such that the weight ratio of the metallocene to the particulate solid is in the range of about 0.00001/1 to 1/1, more preferably 0.0005/1 to 0.2/1.

The prepolymerization is conducted in the liquid catalyst system, which can be a solution, a slurry, or a gel in a liquid. A wide range of olefins can be used for the prepolymerization. Typically, the prepolymerization will be conducted using an olefin, preferably selected from ethylene and non-aromatic alpha-olefins, and as propylene. It is within the scope of the invention to use a mixture of olefins, for example, ethylene and a higher alpha olefin can be used for the prepolymerization. The use of, a higher alpha-olefin, such as 1-butene, with ethylene is believed to increase the amount of copolymerization occurring between the olefin monomer and the olefinically unsaturated portion of the metallocene.

The prepolymerization can be conducted under relatively mild conditions. Typically, this would involve using low pressures of the olefin and relatively low temperatures designed to prevent site decomposition resulting from high concentrations of localized heat. The prepolymerization typically occurs at temperatures in the range of about −15° C. to about +110° C., more preferably in the range of about +10 to about +30° C. The amount of prepolymer can be varied but typically would be in the range of from about 1 to about 95 wt % of the resulting prepolymerized solid catalyst system, more preferably about 5 to 80 wt %. It is generally desirable to carry out the prepolymerization to at least a point where substantially all of the metallocene is in the solid rather than in the liquid since that maximizes the use of the metallocene.

It is also within the scope of the present invention to prepolymerize a combination of the alkenyl substituted indenyl amido metallocene and another metallocene such as a bridged or unbridged metallocene of Ti or Zr. By selecting particular combinations is it possible to produce prepolymerized catalyst system that will yield polymers having different molecular weight distributions, including in some cases bimodal or multimodal molecular weight distributions. One particularly preferred type of metallocene to use in combination with the amido metallocene would be metallocenes of within the scope of those disclosed in U.S. Pat. No. 5,498,581, some examples of which would include 5-(9-fluorenyl)-5-(cyclopentadienyl)-hex-1-ene zirconium dichloride and 1-(9-fluorenyl)-1-(cyclopentadienyl)-1-phenyl-1-(3-butenyl) methylene zirconium dichloride, and the like.

After the prepolymerization, the resulting solid prepolymerized catalyst is separated from the liquid of the reaction mixture. Various techniques known in the art can be used for carrying out this step. For example, the material could be separated by filtration, decantation, or by vacuum evaporation. It is currently preferred, however, not to rely upon vacuum evaporation since it is considered desirable to remove substantially all of the soluble components in the liquid reaction product of the prepolymerization from the resulting solid prepolymerized catalyst before it is stored or used for subsequent polymerization. After separating the solid from the liquid, the resulting solid is preferably washed with a hydrocarbon and then dried using high vacuum to remove substantially all the liquids and other volatile components that might still be associated with the solid. The vacuum drying is preferably carried out under relatively mild conditions, i.e. temperatures below 100° C. More typically the prepolymerized solid is dried by subjection to a high vacuum at a temperature of about 30° C. until a substantially constant weight is achieved. A preferred technique employs at least one initial wash with an aromatic hydrocarbon, such as toluene, followed by a wash with a paraffinic hydrocarbon, such as hexane, and then vacuum drying.

It is within the scope of the present invention to contact the prepolymerization reaction mixture product with a liquid in which the prepolymer is sparingly soluble, i.e. a counter solvent for the prepolymer, to help cause soluble prepolymer to precipitate from the solution. Such a liquid is also useful for the subsequent washing of the prepolymerized solid.

It is also within the scope of the present invention to add a particulate solid of the type aforementioned after the prepolymerization. Thus one can add the solid to the liquid prepolymerization product before the counter solvent is added. In this manner soluble prepolymer tends to precipitate onto the surface of the solid to aid in the recovery of the filtrate in a particulate form and to prevent agglomeration during drying. The liquid mixture resulting from the prepolymerization or the inventive solid prepolymerized catalyst can be subjected to sonification to help break up particles if desired.

Further, if desired the recovered solid prepolymerized catalyst system can be screened to give particles having sizes that meet the particular needs for a particular type of polymerization.

Another option is to combine the recovered inventive solid prepolymerized catalyst system with an inert hydrocarbon, such as one of the type used as a wash liquid, and then to remove that liquid using a vacuum. In such a process it is sometimes desirable to subject the resulting mixture to sonification before stripping off the liquid.

The resulting solid prepolymerized metallocene-containing catalyst system is useful for the polymerization of olefins. Generally, it is not necessary to add any additional aluminoxane to this catalyst system. In some cases it may be found desirable to employ small amounts of an organoaluminum compound as a scavenger for poisons. The term organoaluminum compounds include compounds such as triethylaluminum, trimethylaluminum, diethylaluminum chloride, ethylaluminum dichloride, ethylaluminum sesquichloride, and the like. Trialkyl aluminum compounds are currently preferred. Also in some applications it may be desirable to employ small amounts of antistatic agents which assist in preventing the agglomeration of polymer particles during polymerization. Still further, when the inventive catalyst system is added to a reactor as a slurry in a liquid, it is sometimes desirable to add a particulate dried solid as a flow aid for the slurry. Preferably the solid has been dried using one of the methods described earlier. Inorganic oxides such as silica are particularly preferred. Currently, it is preferred to use a fumed silica such as that sold under the tradename Cab-o-sil. Generally the fumed silica is dried using heat and trimethylaluminum.

The solid catalyst system is particularly useful for the polymerization of alpha-olefins having 2 to 10 carbon atoms. Examples of such olefins include ethylene, propylene, butene-1, pentene-1,3-methylbutene-1, hexene-1, 4-methylpentene-1,3-methylpentene-1, heptene-1, octene-1, decene-1,4,4-dimethyl-1-pentene, 4,4-diethyl-1-hexene, 3,4-dimethyl-1-hexene, and the like and mixtures thereof. The catalysts are also useful for preparing copolymers of ethylene and propylene and copolymers of ethylene or propylene and a higher molecular weight olefin.

The polymerizations can be carried out under a wide range of conditions depending upon the particular metallocene employed and the particular results desired. Although the inventive catalyst system is a solid, it is considered that it is useful for polymerization conducted under solution, slurry, or gas phase reaction conditions.

When the polymerizations are carried out in the presence of liquid diluents obviously it is important to use diluents which do not have an adverse effect upon the catalyst system. Typical liquid diluents include propane, butane, isobutane, pentane, hexane, heptane, octane, cyclohexane, methylcyclohexane, toluene, xylene, and the like. Typically the polymerization temperature can vary over a wide range, temperatures typically would be in a range of about −60° C. to about 300° C., more preferably in the range of about 20° C. to about 160° C. Typically the pressure of the polymerization would be in the range of from about 1 to about 500 atmospheres or even greater. The inventive catalyst system is particularly useful for polymerizations carried out under particle form, i.e., slurry-type polymerization conditions.

The polymers produced with this invention have a wide range of uses that will be apparent to those skilled in the art from the physical properties of the respective polymers. Applications such as molding, films, adhesives, and the like are indicated.

A further understanding of the present invention, its various aspects, objects and advantages will be provided by the following examples.

### Example I

A series of prepolymerized catalysts were prepared using alkenyl substituted indenyl dimethyl silyl t-butyl titanium dihalide half sandwich metallocenes in which the length of the alkenyl group varied from 4 carbons to 7 carbons.

The preparation of the prepolymerized catalyst systems involved adding the specific metallocene to toluene and combining that mixture with a toluene solution of methylaluminoxane to obtain a liquid catalyst system having a Ti/Al molar ratio of 1/1250. A dried silica which had been contacted with trimethyl aluminum was then added and the mixture used to prepolymerize ethylene for 20 minutes. The resulting particulate prepolymerized catalyst was then separated from the liquid and subjected to washing with toluene to remove soluble components. The resulting prepolymerized catalyst systems were then used to carry out the polymerization of ethylene in 250 ml of pentane at 60° C. The results of this comparison are summarized in the following Table.

TABLE

| | | GPC | DSC |
|---|---|---|---|
| | | \overline{M}_{w} [g/mol] | Mp.^{a)} [° C.] |
| | Activity | \overline{M}ₙ [g/mol] | Δ \overline{H}ₘ [J/g] |
| Complex | [g] PE/[mmol] M · h | HI | α^{b)} |
| 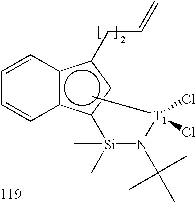 | 2 000 | \overline{M}_{w} > 1 100 000^{c)} | 138.4 161.9 55.8 |
| 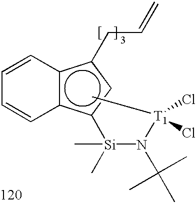 | 48 000 | 2 234 000 896 200 2.49 | 149.1 73.6 25.4 |
| 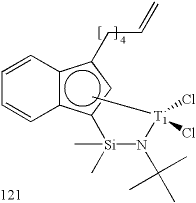 | 39 360 | 2 745 000 727 000 3.78 | 137.2 103.6 35.7 |
| 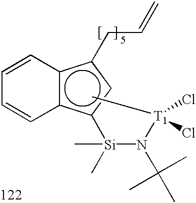 | 800 | 1 078 000 194 300 5.55 | n.b. |

^{a)}Maximum of the melting peak during the 2. heating course of the DSC;
^{b)}α = ΔHₘ/ΔHₘ° with ΔHₘ° = 290 J/g^{[156]};
^{c)}new styra gel HT6E-GPC-column; molecular weight too high.
n.b. = not determined.

The results in the above table demonstrate that the prepolymerized catalyst systems prepared using half sandwich amido metallocenes in which the alkenyl substituent on the indenyl had 5 or 6 carbon atoms were more active than the other two. None of the catalysts caused any evidence of fouling of the reactor.

The polymers produced by homopolymerizing ethylene with the prepolymerized 1-(3-pent-4-enyl indenyl) dimethyl silyl t-butyl titanium dichloride showed the presence of some ethyl branches as revealed by both NMR and the density of the polymer as compared to what would have been expected for a homopolymer of ethylene.

That which is claimed is:

1. A method for preparing a solid metallocene-containing catalyst system comprising (a) combining an alkenyl substituted indenyl (t-butylamido) dimethyl silane titanium half sandwich metallocene in which the alkenyl substituent on the indenyl has terminal olefinic unsaturation and 5 to 6 carbon atoms with a suitable cocatalyst in a liquid to form a liquid catalyst system, (b) conducting prepolymerization of at least one olefin in the presence of said liquid catalyst system to produce a prepolymerized solid catalyst, and (c) separating the resulting solid from the liquid and components dissolved in said liquid.

2. A process according to claim 1 wherein the cocatalyst is selected from organo compounds lithium, aluminum, zinc, and boron.

3. A process according to claim 2 wherein the cocatalyst is an alkyl aluminoxane.

4. A process according to claim 3 wherein a particulate dry silica is combined with the metallocene and the cocatalyst prior to the prepolymerization.

5. A process according to claim 4 wherein the prepolymerization involves the homopolymerization of ethylene.

6. A process according to claim 5 wherein the amido metallocene 1-(3-pent-4-enyl indenyl) dimethyl silyl t-butyl titanium dichloride is employed.

7. A process according to claim 5 wherein the amido metallocene 1-(3-hex-5-enyl indenyl) dimethyl silyl t-butyl titanium dichloride is employed.

8. A particulate prepolymerized catalyst system produced by the process of claim 7.

9. A particulate prepolymerized catalyst system produced by the process of claim 6.

10. A particulate prepolymerized catalyst system produced by the process of claim 1.

11. A process for producing a polymer comprising contacting an olefin with the catalyst system of claim 10 under polymerization conditions.

12. A process according to claim 11 wherein the particulate prepolymerized catalyst system is prepared using 1-(3-pent-4-enyl indenyl) dimethyl silyl t-butyl titanium dichloride.

13. A process according to claim 12 wherein the particulate prepolymerized catalyst system is prepared using methylaluminoxane.

14. A process according to claim 11 wherein the particulate prepolymerized catalyst system is prepared using 1-(3-hex-5-enyl indenyl) dimethyl silyl t-butyl titanium dichloride.

15. A process according to claim 14 wherein the particulate prepolymerized catalyst system is prepared using methylaluminoxane.

16. A process according to claim 11 wherein the polymerization is conducted under slurry polymerization conditions.

17. A process according to claim 15 wherein ethylene is homopolymerized.

18. A process according to claim 13 wherein ethylene is homopolymerized.

19. A process according to claim 13 wherein ethylene is copolymerized with 1-hexene.

20. A process according to claim 15 wherein ethylene is copolymerized with 1-hexene.
